(19) United States
(12) Patent Application Publication
(10) Pub. No.: US 2026/0071496 A1
(43) Pub. Date: Mar. 12, 2026

(54) ELECTRICALLY POWERED CIVIL ENGINEERING MACHINE AND METHOD FOR ELECTRICALLY POWERING A CIVIL ENGINEERING MACHINE

(71) Applicant: BAUER Maschinen GmbH, Schrobenhausen (DE)

(72) Inventors: Matthias OSTERLAND, Schrobenhausen (DE); Marco VOIGT, Schrobenhausen (DE)

(73) Assignee: BAUER Maschinen GmbH, Schrobenhausen (DE)

(21) Appl. No.: 19/320,256

(22) Filed: Sep. 5, 2025

(30) Foreign Application Priority Data
Sep. 6, 2024 (EP) 24198850.0

(51) Int. Cl. E21B 3/02; E21B 7/02; E21B 19/00

(52) U.S. Cl. CPC E21B 3/022; E21B 19/008; E21B 7/02

(57) ABSTRACT

The invention relates to an electrically operated civil engineering machine with a mobile carrier device, at least one electrical consumer unit, at least one internal rechargeable battery unit for storing and supplying electrical energy, at least one supply device for supplying electrical energy from an external energy source, and a circuit arrangement for supplying and discharging electrical energy to and from the at least one electrical consumer unit as required, wherein the circuit arrangement is configured to distribute electrical energy between the at least one electrical consumer unit and the supply device by means of an intermediate circuit. According to the invention, it is provided that the circuit arrangement comprises a first intermediate circuit and a second intermediate circuit, that the first intermediate circuit can be operated with a first voltage level and that the second intermediate circuit can be operated with a second voltage level which is different from the first voltage level.

The invention relates to an electrically powered civil engineering machine with a mobile carrier device, at least one electrical consumer unit, at least one internal rechargeable battery unit for storing and supplying electrical energy, at least one supply device for supplying electrical energy from an external energy source, and a circuit arrangement for supplying and discharging electrical energy to and from the at least one electrical consumer unit as required, wherein the circuit arrangement is configured to distribute electrical energy between the at least one electrical consumer unit and the supply device by means of an intermediate circuit, according to the preamble of claim 1.

The invention further relates to a method for electrically operating a civil engineering machine with a mobile carrier device, at least one electrical consumer unit, at least one internal rechargeable battery unit for storing and supplying electrical energy, at least one supply device for supplying electrical energy from an external energy source, and a circuit arrangement for supplying and discharging electrical energy to and from the at least one electrical consumer unit as required, wherein the circuit arrangement distributes electrical energy between the at least one electrical consumer unit and the supply device by means of an intermediate circuit, according to the preamble of claim 10.

Purely electrically powered civil engineering machines have been known for a long time and are used in particular at work sites where noise, vibrations and exhaust gases are undesirable, as they appear increasingly with civil engineering machines powered by combustion engines. Due to the high energy requirements of such electrically powered civil engineering machines, they have a supply device for supplying electrical energy from an external power source, in particular an electrical power supply network. This requires the provision of an appropriate electrical cable.

Furthermore, electrically powered civil engineering machines are also equipped with a rechargeable battery unit, which serves, in particular to supply the mobile civil engineering machine with sufficient electrical energy during movement or travel, during which the electrical cable connection is frequently disconnected.

The storage of electrical energy in an internal battery unit also allows additional electrical energy to be drawn from the internal battery unit to cover peak energy requirements of the civil engineering machine which cannot be fully covered by the normal energy supply via the supply device from the connected external power supply network.

For efficient operation of the civil engineering machine, it is here of fundamental importance that the energy is controlled and distributed to the civil engineering machine in accordance with demand. EP 4 245 923 B1 describes an electrically powered civil engineering machine with an intermediate circuit and a supply device. The intermediate circuit is configured as an electrical conductor to which consumer units, in particular a battery unit and an electric motor, are connected. Electrical energy can be supplied here from the intermediate circuit to an electric motor via an inverter unit, wherein the inverter unit is configured to return energy to the intermediate circuit in a recuperation mode of the electric motor. For efficient energy distribution, the voltage of the intermediate circuit is controlled depending on a voltage in the intermediate circuit by means of control components assigned to individual consumer units.

The invention addresses the object of specifying an electrically operated civil engineering machine and a method for operating it, which enable particularly economical and efficient operation of the civil engineering machine.

The object is solved on the one hand by a civil engineering machine with the features of claim 1 and on the other hand by a method with the features of claim 10. Preferred embodiments are specified in the respective dependent claims.

The civil engineering machine according to the invention is configured in such a way that the circuit arrangement comprises a first intermediate circuit and a second intermediate circuit, that the first intermediate circuit can be operated with a first voltage level and that the second intermediate circuit can be operated with a second voltage level which is different from the first voltage level.

A basic idea behind the invention is to exit a single central intermediate circuit in the power supply system on board of an electrically powered civil engineering machine. This is achieved by providing a circuit arrangement with two intermediate circuits carrying two different voltage levels. Different consumer units for different operating ranges are assigned to the different intermediate circuits. Depending on the energy and power consumption, the respective consumer units can be connected to an intermediate circuit as required, thereby eliminating the need for additional converters. The different voltage levels make the system very flexible in its overall application. Depending on the operating mode of the construction machine, the intermediate circuits can be supplied in various ways with a supply device from a local power supply network and directly from a battery unit. This ensures that certain consumer units can also be operated without a power connection to a local power supply network when the civil engineering machine is being adjusted or moved.

A preferred embodiment of the invention is that at least two intermediate circuits are provided. Thereby, it is advantageous if the intermediate circuits each have different voltage levels, wherein the voltage levels are adapted to the operation of certain consumers, for example to avoid additional converter units. It is particularly advantageous if the intermediate circuits are configured redundantly to compensate for possible failures. This ensures particularly safe operation.

In principle, the intermediate circuits can be configured as desired. A particularly advantageous embodiment of the invention is achieved in that the intermediate circuits can be operated independently of one another as closed circuits and in that at least two intermediate circuits can be connected to a total circuit by means of a switching device, in particular a disconnecting device. The switching device can be configured, in particular as a protective switch for disconnecting and connecting the intermediate circuits. The switching device can also be configured as a converter unit for establishing an electrical connection. By connecting the two intermediate circuits with a switching device, electrical energy can be conducted from one intermediate circuit to the other as required. It is particularly advantageous if the first intermediate circuit is connected to the second intermediate circuit via a DC/DC controller, wherein the battery unit is configured to compensate for load peaks. This allows power peaks occurring forming during operation to be compensated immediately by the battery unit. Conversely, when the civil engineering machine according to the invention is operated on a power supply network, excess energy can be fed from the first intermediate circuit to the second intermediate circuit to charge the battery unit. According to a further development of the invention, it is equally useful for the first intermediate circuit to be connectable to the second intermediate circuit, wherein the first and second intermediate circuits have the same voltage level. Here, the battery unit may be provided to compensate for power peaks.

The switching device can be configured with a safety device to disconnect the connection between the first and second intermediate circuits in the event of sudden power peaks. It is useful if the switching device can be controlled by a control unit so that, for example, the intermediate circuits can be disconnected or connected depending on the operating state of the civil engineering machine by means of an input by the operating personnel.

A further advantageous configuration of the invention is that an intermediate circuit is configured to supply and discharge electrical energy to and from the battery unit, wherein the battery unit is configured to control the voltage level in order to compensate for power peaks of the intermediate circuit. By suitably designing the voltage level of the intermediate circuit, the battery unit can preferably be connected to the intermediate circuit without an additional converter unit. The voltage level of the intermediate circuit can here, for example, be between about 400 volts and 800 volts. The voltage level is thus controlled centrally depending on the state of charge of the battery unit.

A particularly useful development of the invention is that at least one consumer unit comprises a DC/DC controller. This allows a large number of peripheral devices, such as a cooling device and a heating device, to be connected to the circuit arrangement in a particularly efficient manner. The DC/DC controller can be configured separately from the consumer unit or as a unit with the consumer unit. It is useful if the DC/DC controller is configured for bidirectional power supply. It is particularly advantageous if the DC/DC controller is connected to a low-voltage electrical system on board, preferably a 12-volt, 24-volt and/or 48-volt electrical system on board with at least one intermediate circuit. The DC/DC controller can convert a DC voltage supplied to an input into a DC voltage with a higher, lower or inverted voltage level. Such DC controllers are in particular self-controlled current converters.

According to another embodiment variant of the invention, it is advantageous that the intermediate circuits are configured to conduct and distribute direct current.

A further particularly advantageous configuration of the invention is that the at least one electrical consumer unit is configured as an electric motor, wherein the electric motor is assigned an inverter unit which is configured to convert direct current into alternating current. The inverter unit comprises, in particular, a rectifier or inverter which can convert current in both directions. In this way, direct current from the intermediate circuit can be supplied to the electric motor as alternating current on the one hand, while electrical energy generated in a recuperation mode of the electric motor can be converted from alternating current to direct current for delivery to the intermediate circuit on the other hand.

A particularly advantageous development of the invention is achieved in that a first supply device is configured to supply and convert electrical energy, in particular alternating voltage, from a first electrical power supply network with a first voltage, and in that a second supply device is configured to supply and convert electrical energy, in particular alternating voltage, from a second electrical power supply network with a second voltage, wherein the second voltage is different from the first voltage. By forming two supply devices, the civil engineering machine according to the invention can be supplied with electrical energy in a particularly versatile and flexible manner depending on the operating state. The second supply device can preferably be configured to charge the battery unit and/or for limited operation of the civil engineering machine when the first supply device is not supplied with electrical energy. Generally possible operating modes of the civil engineering machine according to the invention are exemplary explained in more detail below in the description of the figures.

It is advantageous if the first supply device is configured to supply an electrical power of at least 100 kVA, preferably several 100 kVA. It is particularly useful if the supplied voltage level of the first supply device is greater than or equal to the supplied voltage level of the second supply device. In particular, a supplied voltage level of 690 V as AC can be provided for the first supply device. In particular, 400 V AC can be provided as the supplied voltage level for the second supply device. It is also particularly useful if the supplied first voltage level of the first supply device corresponds to the supplied second voltage level of the second supply device.

In principle, both the first supply device and the second supply device can be connected to a first or second power supply network, for example with 690 volts or 400 volts, and can comprise at least one converter unit. The converter unit can preferably be configured as a rectifier for converting alternating voltage from the power supply or as a transformer. The electrically operated civil engineering machine may have a first supply device as a primary supply for supplying electrical energy for regular work operation and a second supply device as a secondary supply for supplying energy to the peripheral consumer units and the battery unit.

According to a further development of the invention, it may be useful for the second supply device to be assigned a transformer unit and for the second supply device to be configured to supply and convert electrical energy from the first electrical power supply network with the first voltage. This means that electrical energy from the first electrical power supply network can be supplied to both the first and second intermediate circuits. The electric civil engineering machine can thus be connected to a local power supply network in stationary operation, for example, and thus can be operated entirely electrically, wherein the battery unit can also be charged. This ensures particularly environmentally friendly operation of the civil engineering machine in an urban environment. Alternatively or in addition thereto, the electric civil engineering machine can be operated separately from the power supply using the battery unit. This means that purely electric battery operation can be provided, particularly for adjusting or moving. It is useful for this purpose if the battery unit is charged independently of the first supply device by connecting it to a local power supply via the second supply device.

The civil engineering machine may have a boom or a mast on which a drilling drive with a drilling tool, a diaphragm wall cutter, a diaphragm wall gripper, a vibrator or a pile driver are arranged.

The method according to the invention is characterised in that the circuit arrangement comprises a first intermediate circuit and a second intermediate circuit, wherein the first intermediate circuit is operated with a first voltage level and in that the second intermediate circuit is operated with a second voltage level which is different from the first voltage level.

The method can be used, in particular in the civil engineering machine according to the invention described above. In this case, the advantages described above can be achieved.

A preferred method variant of the invention consists in the intermediate circuits being operated independently of one another as closed circuits and that, if necessary, the intermediate circuits are connected to a total circuit by means of a switching device, in particular a DC/DC controller, wherein electrical energy is distributed between the two intermediate circuits as required. In particular, when load peaks occur in one intermediate circuit, electrical energy can such be supplied from one intermediate circuit to the other to balance the load. It is advantageous if the voltage levels of the respective intermediate circuits are configured for the power requirements of the consumer units, in particular the milling machine and an electric motor, in order to reduce cable cross-sections and thus weight. The two different voltage levels also eliminate the need for additional converter devices, which significantly improves energy efficiency. In principle, the failure of one supply device can be compensated for by creating a complete circuit and designing several supply devices. It is particularly advantageous that the intermediate circuits are connected to a total circuit and that the consumer units of the first and second intermediate circuits or further intermediate circuits are operated with the same voltage level.

It is advantageous if the first intermediate circuit is provided as a power section, in particular as a high-performance electrical system on board, with a voltage level of approximately 800 volts up to 1,500 volts, in particular 1,100 volts. The second intermediate circuit can preferably be provided as a peripheral part, in particular as a low-power on-board network, with a lower voltage level, in particular between 600 volts and 800 volts or also between 300 volts and 400 volts. Alternatively thereto, both intermediate circuits can have the same voltage level, in particular the lower voltage level between 300V and 800V. This reduces the complexity of the switching device.

According to the invention, another particularly advantageous method variant consists in the fact that, by means of a first supply device, electrical energy, in particular alternating voltage, is supplied from a first electrical power supply network with a first voltage and, in particular, is converted, and by means of a second supply device, electrical energy, in particular alternating voltage, from a second electrical power supply network with a second voltage is supplied and, in particular, is converted, wherein the second voltage is different from the first voltage. In other words, according to the method of the invention, the civil engineering machine can be operated with electrical energy from a first electrical power supply network and/or from a second electrical power supply network. If required, energy can be supplied to both the first and second intermediate circuits from the first and/or second electrical power supply network. The energy can here be supplied to the respective intermediate circuit both via the supply device and via the switching device. This enables reliable and fast energy distribution.

The invention is further explained below with reference to preferred exemplary embodiments, which are schematically illustrated in the drawings. The drawings show

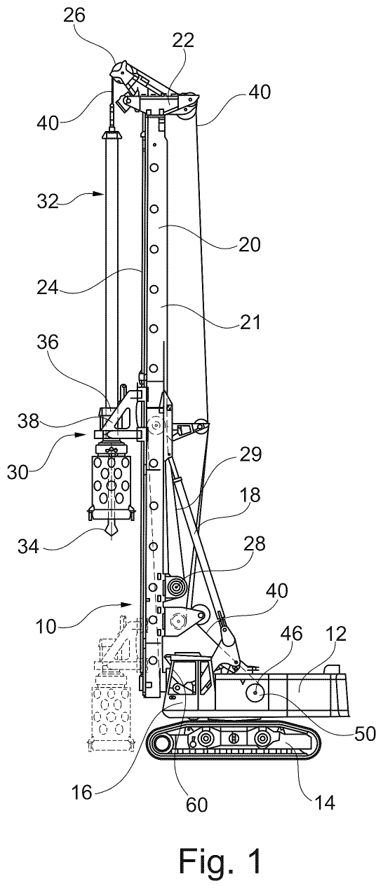

FIG. 1 a side view of a civil engineering machine according to the invention;

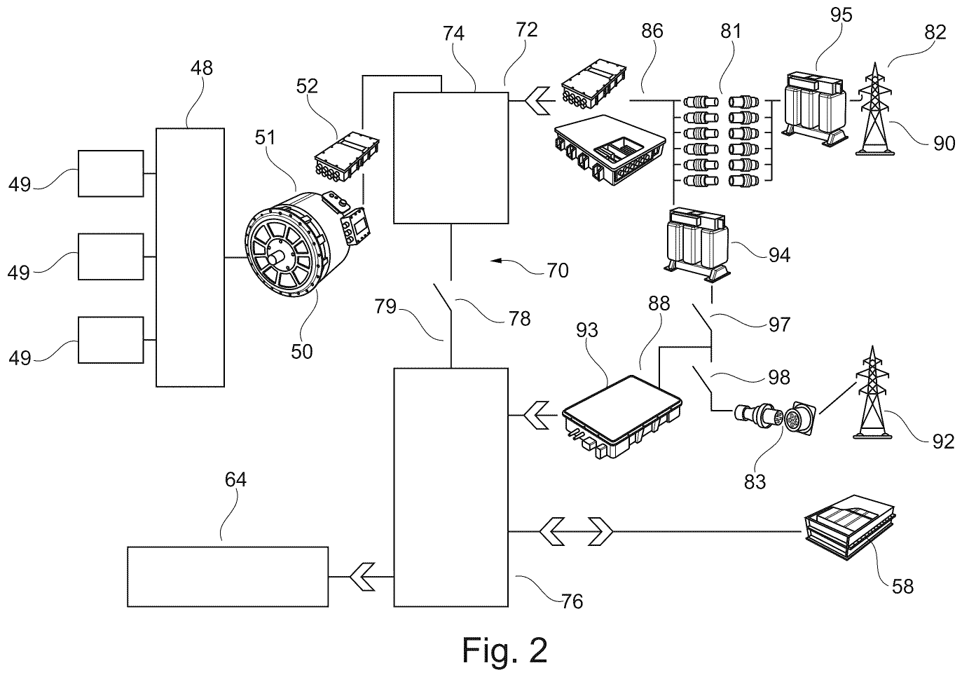

FIG. 2 a schematic representation of a circuit arrangement according to the invention with two intermediate circuits and possible components;

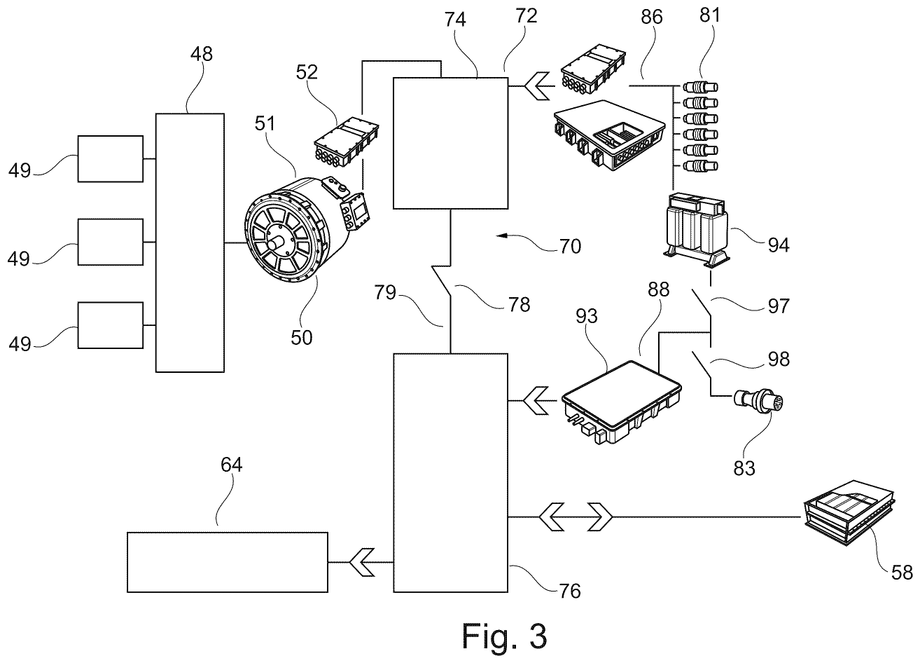

FIG. 3 a schematic representation of a circuit arrangement according to the invention according to an additional operating mode of the civil engineering machine;

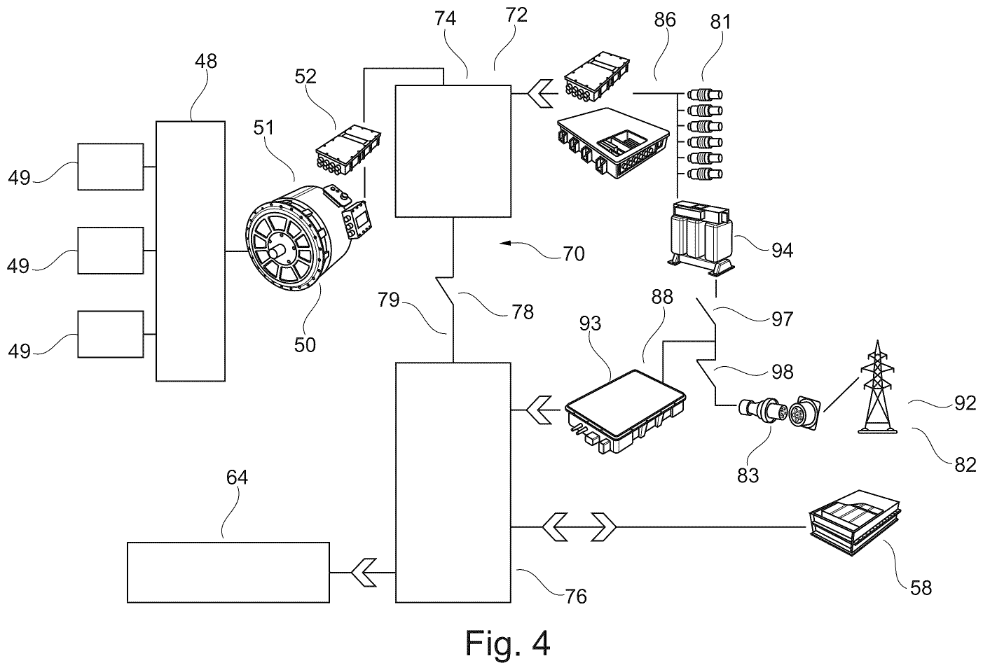

FIG. 4 a schematic representation of a circuit arrangement according to the invention according to an additional operating mode of the civil engineering machine;

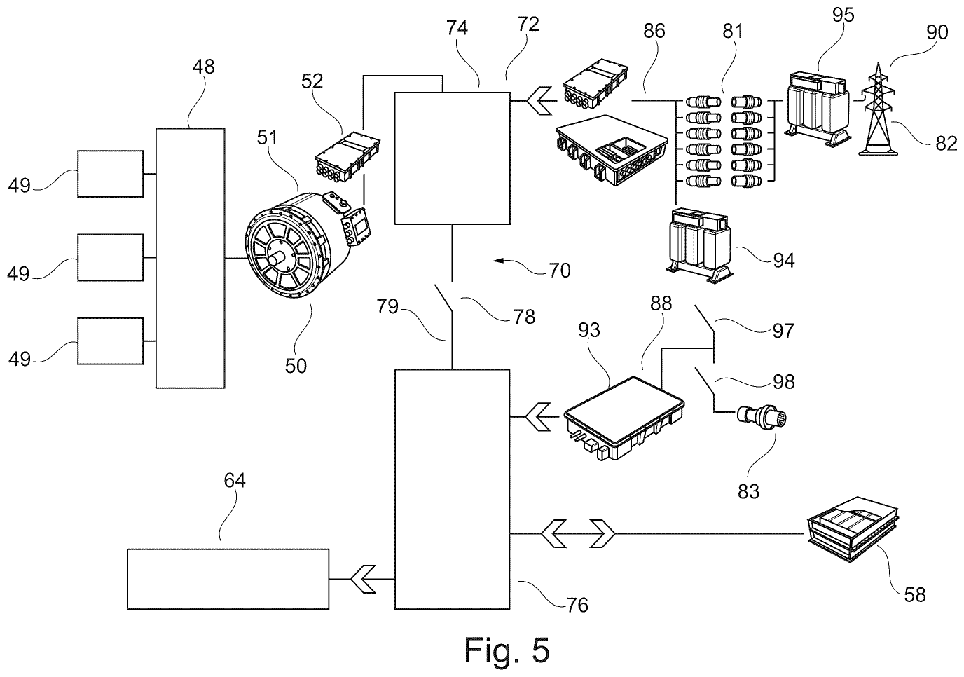

FIG. 5 a schematic representation of a circuit arrangement according to the invention according to an additional operating mode of the civil engineering machine;

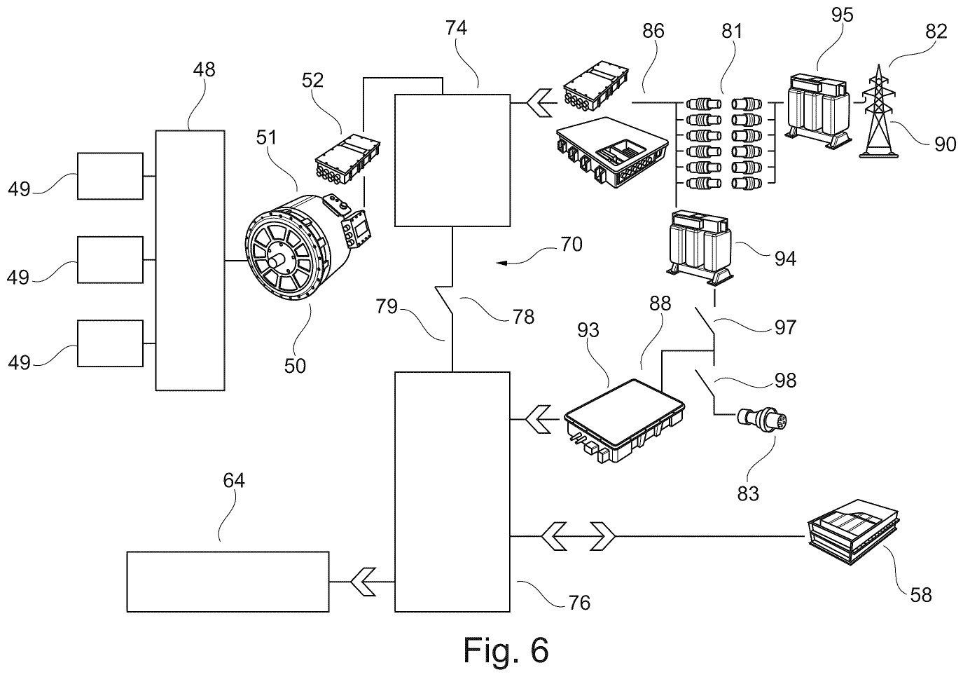

FIG. 6: a schematic representation of a circuit arrangement according to the invention according to an additional operating mode of the civil engineering machine; and

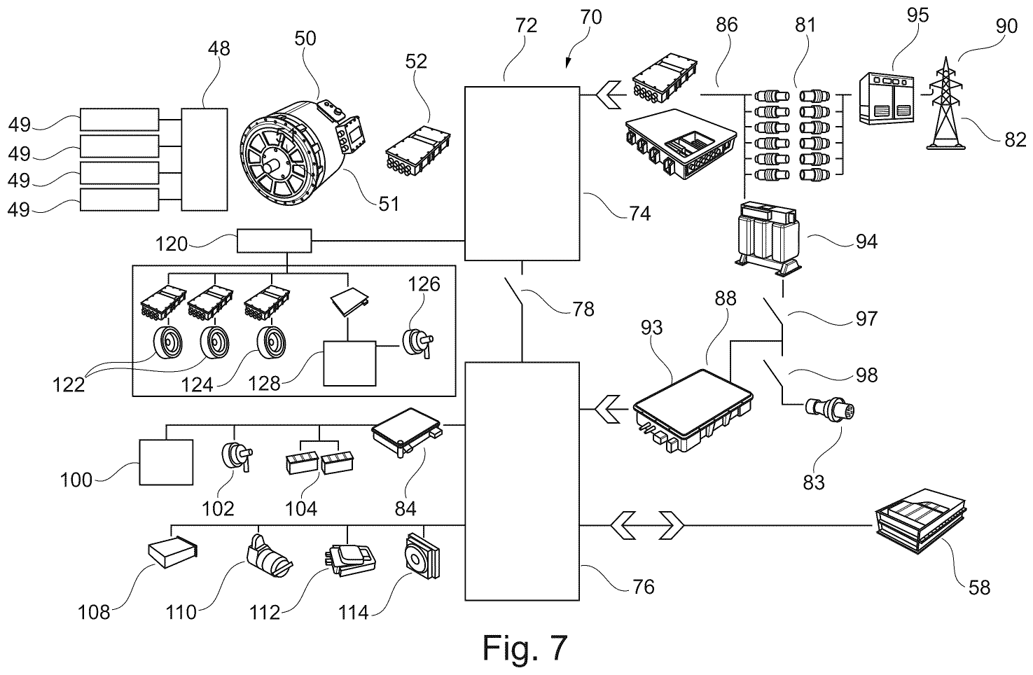

FIG. 7: a schematic representation of a circuit arrangement according to the invention with two intermediate circuits and supplemented possible components.

A civil engineering machine 10 according to the invention with a carrier device 12 is shown in FIG. 1. The carrier device 12 can preferably comprise a crawler track as an undercarriage 14, on which a superstructure 16 can be mounted, in particular in a rotatable manner. A control system 60 for the civil engineering machine 10 may be located in an operating cabin of the superstructure 16. In particular, a beam-like machine component, in particular a mast 20 shown here, may be mounted on the superstructure 16 in a preferably adjustable manner via a linkage mechanism 18 to form a lifting device. The mast 20 can preferably be configured as a leader 21 with a linear guide 24 along the mast 20 and can have a substantially vertical position during operation. The beam-like machine component, in particular the mast 20, can also be connected directly to the superstructure 16 via a joint, not shown, which is arranged in the lower region of the beam-like machine component, as well as one or more actuating cylinders, not shown. Also in accordance with the invention, it is also possible for the beam-like machine component to be a boom, which can be angled and is not shown, instead of the mast 20, which can be arranged in an adjustable manner on the superstructure 16.

According to the exemplary embodiment shown, the mast 20 can preferably be configured as a leader 21 with a linear guide 24 on its front side. A working carriage 38 with a rotary drilling drive 36 can be mounted vertically along the linear guide 24, for example. This allows the civil engineering machine 10 to be configured as a drilling rig. The drawing shows an example of the central position of the rotary drilling drive 36 as well as a lower position with a broken line.

A cable 40 can be guided over a mast head 22 at the upper end of the mast 20, at one end of which a preferably telescopic Kelly bar 32 with an exemplary auger 34 can be provided to form a deep excavation tool 30. The Kelly bar 32 can be guided by a sleeve-shaped drive wheel of the rotary drilling drive 36 on the working carriage 38, so that a torque can be transmitted from the rotary drilling drive 36 to the Kelly bar 32 via drive strips, not shown. The drill auger 34 for creating a borehole in the ground can be arranged at the lower end of the Kelly bar 32. The drilling tool can be configured in any way and can, in particular comprise a drill auger 34 or a drill bucket.

The cable 40 can be guided from the Kelly bar 32 via deflection rollers 26 on the mast head 22 along the mast 20 up to a cable winch 46 in the superstructure 16. The cable winch 46 is driven by an electric motor 50, which can also be operated in a recuperation mode. The Kelly bar 32 with the drill auger 34 can be raised and lowered by means of the cable 40 via the cable winch 46. During lowering, potential energy can be converted into electrical energy by the electric motor 50 and fed to an intermediate circuit, which is described in more detail below.

The working carriage 38 with the rotary drilling drive 36 can be pulled upwards via a further control cable 29 by means of an actuator 28 with a winch on the mast 20. By appropriate driving the actuator 28 in the opposite direction, the working carriage 38 with the rotary drilling drive 36 can also be lowered. Similarly, the working carriage 38 can be pulled down by the actuator 28. The rotary drilling drive 36 can be formed by a top drive with at least one additional electric motor. The actuator 28 can also be equipped with an electric motor (not shown), which can also be operated in recuperation mode. The working carriage 38 with the rotary drilling drive 36 can also be regarded as part of the mining tool 30.

The control system 60 controls the at least one electric motor 50 for operating the cable winch 46 and, preferably, also the further electric motor for operating the actuator 28 configured as a winch.

FIG. 2 schematically shows a circuit arrangement 70 according to the invention with a first intermediate circuit 74 and a second intermediate circuit 76, wherein the first intermediate circuit 74 can be configured, in particular as a DC-powered DC link with a defined voltage of, for example, 1100 volts. The second intermediate circuit 76 can preferably be operated with a defined voltage of 600 volts to 800 volts, but also with lower voltages of approximately 400 volts, also with direct current.

The first intermediate circuit 74 can be configured to be connectable to a first supply device 86 with an external energy source 82 for primary energy supply. The energy source 82 can be, in particular, an alternating power supply network. The alternating voltage can be 690 volts, for example. The supply device 86 can preferably comprise connection plugs or terminals and a converter unit. The connection to the first supply device 86 can therefore preferably take place with a detachable first plug connection 81 on the civil engineering machine 10.

The energy can be transferred from the energy source 82 to the intermediate circuit 74, in particular via an isolating transformer 95 and a converter device for converting the alternating current into direct current. It is particularly advantageous if the supply device 86 is configured to convert alternating voltage into direct voltage.

For further energy supply, the second intermediate circuit 76 can also have a second supply device 88 for connecting the circuit arrangement 70 to a second electrical power supply network 92. The second electrical power supply network 92 can, for example, carry an alternating voltage of approximately 400 volts. The supply device 88 may, in particular comprise a converter unit, preferably an onboard charger 93, and a detachable second plug connection 83.

The onboard charger 93 shown schematically in FIG. 2 can, in particular, convert the AC voltage of the second plug connection 83 into the DC voltage required for the second intermediate circuit 76.

As shown here, a battery unit 58 and further electrical consumer units 64 can be electrically connected to the second intermediate circuit 76. Electrical energy can be supplied to or removed from the at least one battery unit 58 to operate the electrical consumer units 64. The internal battery unit 58 can be configured to be replaceable, in particular as a replaceable accumulator.

According to the invention, the circuit arrangement 70 does not consist of a uniform intermediate circuit 72. Rather, the circuit arrangement 70 comprises at least a first intermediate circuit 74 and a second intermediate circuit 76, which can be connected to a switching device 78. This means that by actuating the switching device 78, the intermediate circuits 74, 76 can be connected to a total circuit 79. The electrical connection thus established allows electrical energy to be distributed as desired from one intermediate circuit 74, 76 to the other, depending on the power requirement and operating state. For example, energy can be dissipated from the battery unit 58 and fed via the switching device 78 to an electric motor 51 as a consumer unit 50. The electric motor 51 can, for example, drive one or more components 49, such as pumps, in particular hydraulic pumps, via a distribution gearbox 48. The switching device 78 can preferably be configured as a contactor switch, DC/DC controller and/or inverter.

The power supply of the circuit arrangement 70 according to the invention with the first intermediate circuit 74 and the second intermediate circuit 76 can in principle be configured in a variety of ways. In accordance with the second intermediate circuit 76 shown in FIG. 2, it is advantageous that the second supply device 88 can be configured to obtain electrical energy from the second electrical power supply network 92 and/or from the first electrical power supply network 90 by means of an isolating transformer 95.

The second supply device 88 can, in particular comprise an onboard charger 93, a detachable plug connection 83 and/or at least one additional switching device 97, 98. In particular, with a first additional switching device 97, the second supply device 88 can be configured to selectively supply electrical energy to the second intermediate circuit 76 from the first electrical power supply network 90. With a second additional switching device 98, the supply device 88 can be configured to selectively supply electrical energy to the second intermediate circuit 76 from the second electrical power supply network 92. FIG. 2 shows in particular an operating mode with switching devices 78, 97, 98 open, in which electrical energy from the first electrical power supply network 90 is supplied to the first intermediate circuit 74 by means of the first supply device 86. The second intermediate circuit 76 can be supplied from the second electrical power supply network 92, for example to charge a battery unit 58 or to supply electrical consumer units 64, in particular peripheral units and/or cooling units.

The civil engineering machine 10 according to the invention can be supplied with electrical energy in a variety of ways via the first intermediate circuit 74 and the second intermediate circuit 76. The circuit arrangements 70, which are described below in conjunction with FIGS. 3 to 7, can preferably be configured like the circuit arrangement 70 in FIG. 2, wherein like elements are assigned the same reference signs and are not described multiple times to avoid repetition.

According to the circuit arrangement 70 of the invention shown schematically in FIG. 3, the first intermediate circuit 74 can be connected to the second intermediate circuit 76, in particular for travel and set-up operation, by means of the switching device 78. As shown in FIG. 3, the first supply device 86 does not need to be connected to an external energy source, i.e. a power supply network. The plug connections 81, 83 to external energy sources can be disconnected. Instead, the energy supply for the civil engineering machine 10 according to the invention is provided by the battery unit 58, which is connected to the second intermediate circuit 76. Here, the voltage level of the first intermediate circuit 74 and the second intermediate circuit 76 can preferably correspond to the voltage level of the battery unit 58. The voltage level can be, in particular, approximately 600 volts to 800 volts, but also approximately 300 volts to 400 volts, and can depend on the state of charge of the battery unit 58.

According to the operating arrangement shown in FIG. 3, the civil engineering machine 10 according to the invention can be operated entirely by battery power, in particular for a process of the civil engineering machine 10 approximately up to a distance of several hundred metres from a first operating position to a second operating position at a construction site or for set-up operations.

As illustrated in FIG. 4, in a further operating mode, electrical energy can additionally be supplied by connecting the second supply device 88 to a second electrical power supply network 92, in particular with an alternating voltage of 400 volts. However, this is not absolutely necessary. A second intermediate circuit 76, as shown in FIG. 4, can be supplied from the second power supply network 92, for example to charge a battery unit 58 or to supply electrical consumer units 64, in particular peripheral units.

In the configurations shown in FIGS. 3 and 4, the machine can also be operated, if necessary, at reduced power due to the lower voltage level in the first intermediate circuit 74.

According to FIG. 5, the circuit arrangement 70 can be connected to a 690-volt AC power supply network, in particular for supplying power to an intermediate circuit 72 during regular machine operation. In regular machine operation, a second intermediate circuit 76, as shown in FIG. 5, can be supplied with power, preferably from the 690-volt alternating voltage network as the first power supply network 90, with a second supply device 88 comprising a closed switching device 97 and an onboard charger 93, with an isolating transformer 95 and with a transformer unit 94, wherein a switching device 78 is open. The first intermediate circuit 74 is supplied here in particular via the first supply device 86. The second intermediate circuit 76 can preferably also be supplied from the 690-volt AC network as the first power supply network 90 with the transformer unit 94, the closed switching device 97 and the onboard charger 93, wherein the transformer unit 94 can be configured in particular to convert a voltage level of 690 V to a voltage level of 400 V. The peripheral consumers, such as the cooling system, but also the battery unit 58, can thus be supplied with electrical energy. When the switching device 78 is open, the voltage of the first intermediate circuit 74 can preferably be higher than the voltage of the second intermediate circuit 76, wherein the difference can be between approximately 500 volts and 300 volts in particular.

Alternatively to that, a civil engineering machine 10 according to the invention can be operated in a restricted machine mode in accordance with a circuit arrangement 70 shown schematically in FIG. 6, wherein a first supply device 86 of a first intermediate circuit 74 is connected to a local 400-volt alternating voltage. Here, the first intermediate circuit 74 and a second intermediate circuit 76 can preferably be connected to the closed switching device 78, wherein the resulting total voltage level can correspond to the battery voltage level of the battery unit 58.

It is also possible that the first intermediate circuit 74 and the second intermediate circuit 76 are not electrically connected, wherein the voltage of the first intermediate circuit 74 is higher than the voltage of the second intermediate circuit 76. In this case, the energy supply to a second supply device 88 can preferably be provided from the first electrical power supply network 90, in particular with a voltage level of 400 V.

FIG. 7 shows an operating mode of a circuit arrangement 70 according to the invention in regular machine operation. In addition, FIG. 7 schematically shows as examples various other possible consumer units, each of which is assigned to an intermediate circuit. The electrical consumer units can, in principle, be assigned to any intermediate circuit. According to the circuit arrangement 70 of the invention shown in FIG. 7, a first intermediate circuit 74 can preferably be used as a power part for operating at least one electric motor 51, which, via a distribution gearbox 48, drives components 49 such as one or more pumps, one or more winches, one or more rotary drives, one or more drilling drives, a chassis, and/or one or more actuating cylinders, as well as for operating a milling machine 120, in particular for driving one or more milling wheel motors 122, one or more motor feed pumps 124, one or more flushing agent pumps 126 and/or for operating a low-voltage milling network 128.

Furthermore, a second intermediate circuit 76 with a lower voltage may preferably be provided for operating a battery unit 58 as well as peripheral consumer units, in particular a battery air conditioning system 108, an air conditioning compressor 110, a heater 112 and/or a fan drive 114. These consumer units can generally be connected to the second intermediate circuit 76 by means of a DC/DC controller (not shown) or another converter unit.

Alternatively or in addition to that, a low-voltage circuit 100, in particular a 12-volt, 24-volt or 48-volt electrical system on board, can be assigned to the second intermediate circuit 76 by means of a DC/DC controller 84. According to the embodiment variant shown in FIG. 7, the low-voltage circuit 100 may comprise a water pump 102 and two 12 V batteries 104 connected in series.

1. Electrically powered civil engineering machine with
a mobile carrier device,
at least one electrical consumer unit,
at least one internal rechargeable battery unit for storing and supplying electrical energy,
at least one supply device for supplying electrical energy from an external energy source, and
a circuit arrangement for supplying and discharging electrical energy to and from the at least one electrical consumer unit as required, wherein the circuit arrangement is configured to distribute electrical energy between the at least one electrical consumer unit and the supply device by means of an intermediate circuit,
wherein
the circuit arrangement comprises a first intermediate circuit and a second intermediate circuit,
the first intermediate circuit can be operated with a first voltage level and,
the second intermediate circuit can be operated with a second voltage level which is different from the first voltage level.

2. Electrically operated civil engineering machine according to claim 1,
wherein
at least two intermediate circuits are provided.

3. Electrically operated civil engineering machine according to claim 1,
wherein
the intermediate circuits can be operated independently of one another as closed circuits, and
two intermediate circuits can be connected to a total circuit by means of a switching device, in particular a disconnecting device.

4. Electrically operated civil engineering machine according to claim 1,
wherein
a intermediate circuit is configured for supplying and discharging electrical energy to and from the battery unit, wherein the battery unit is configured to control the voltage level in order to compensate for power peaks in the secondary circuit.

5. Electrically powered civil engineering machine according to claim 1,
wherein
at least one consumer unit comprises a DC/DC controller.

6. Electrically powered civil engineering machine according to claim 1,
wherein
the intermediate circuits are configured to conduct and distribute direct current.

7. Electrically operated civil engineering machine according to claim 1,
wherein
the at least one electrical consumer unit is configured as an electric motor, wherein the electric motor is assigned an inverter unit which is configured to convert direct current into alternating current.

8. Electrically powered civil engineering machine according to claim 1,
wherein
a first supply device is configured to supply and convert electrical energy, in particular alternating voltage, from a first electrical power supply network with a first voltage, and
a second supply device is configured to supply and convert electrical energy, in particular alternating voltage, from a second electrical power supply network with a second voltage, wherein the second voltage is different from the first voltage.

9. Electrically powered civil engineering machine according to claim 8,
wherein
a transformer unit is assigned to the second supply device and the second supply device is configured to supply and convert electrical energy from the first electrical power supply network with the first voltage.

10. Method for electrically operating a civil engineering machine, in particular according to claim 1, with
a mobile carrier device,
at least one electrical consumer unit,
at least one internal rechargeable battery unit for storing and supplying electrical energy,
at least one supply device for supplying electrical energy from an external energy source, and
a circuit arrangement for supplying and discharging electrical energy to and from the at least one electrical consumer unit as required, wherein the circuit arrangement distributes electrical energy between the at least one electrical consumer unit and the supply device by means of an intermediate circuit,
wherein
the circuit arrangement comprises a first intermediate circuit and a second intermediate circuit,
the first intermediate circuit is operated with a first voltage level, and
the second intermediate circuit is operated with a second voltage level which is different from the first voltage level.

11. Method according to claim 10,
wherein
the intermediate circuits are operated independently of one another as closed circuits, and
in that, if necessary, the intermediate circuits are connected to a total circuit by means of a switching device, in particular a DC/DC controller, wherein electrical energy is distributed between the two intermediate circuits as required.

12. Method according to claim 10,
wherein
electrical energy, in particular alternating voltage, is supplied from a first electrical power supply network with a first voltage by means of a first supply device and, in particular, is converted, and
electrical energy, in particular alternating voltage, is supplied from a second electrical power supply network with a second voltage by means of a second supply device and, in particular, is converted, wherein the second voltage is different from the first voltage.
